(19) United States
(12) Patent Application Publication
(10) Pub. No.: US 2018/0172126 A1
(43) Pub. Date: Jun. 21, 2018

(54) METHOD AND APPARATUS FOR POWER DISTRIBUTION

(71) Applicant: Greg Zahner, Lawson, MO (US)

(72) Inventor: Greg Zahner, Lawson, MO (US)

(21) Appl. No.: 15/381,738

(22) Filed: Dec. 16, 2016

(51) Int. Cl. F16H 37/12; F16H 7/06

(52) U.S. Cl. CPC F16H 37/124; F16H 7/06

(57) ABSTRACT

An apparatus including a head sprocket having a bore hole with a first oblong shape consisting of first, second, third, and fourth sides, the first side of the first oblong shape parallel to the second side of the first oblong shape and spaced apart from the second side of the first oblong shape, wherein the first and second sides of the first oblong shape are straight, the third and fourth sides of the first oblong shape are spaced apart from each other, substantially perpendicular to the first and second sides of the first oblong shape, wherein the third and fourth sides of the first oblong shape are curved. The apparatus may also include a crank having a crank head having a first surface with a second oblong shape similar to the first oblong shape. The crank head fits snugly into the bore hole of the head sprocket.

### FIELD OF THE INVENTION

This invention relates to improved methods and apparatus for transferring power from a power source such as a DC (direct current) motor, AC (alternating current) motor or gas engine to a variety of devices such as pumps, cleaning machines, and sanders.

### BACKGROUND OF THE INVENTION

There are a variety of ways power distribution is done for machines such as pumps, cleaning machines and sanders. However in certain applications there is a loss of power transmission due to slippage of a belt, chain and or sprocket slop of such devices. Also at times for various cleaning devices the profile created by a machine is too tall to clean underneath tight areas. So a need exists to provide a better way to transfer power while at the same time making a low profile way to get power to its intended unit. Whether it is a sander, a pump, or a cleaning machine to get under and in tight places, typically there are areas that a pump is situated in a tight confined space, and a lower profile accurate transmission of power is needed. Additionally in the case of sanders per se a need exists to fully utilize the motor power without loss of power due to power transfer. Additionally, a need exists to embody equipment such as a cleaning machine to scrub underneath in tight areas and allow a lower profile and proper transfer of power for efficient cleaning.

### SUMMARY OF THE INVENTION

One or more embodiments of the present invention allow for better power transmission and distribution to a variety of devices for various industries, such as the rental industry, hospitals, and cleaning industries. Unlike known machines, one or more embodiments of the present invention provide an apparatus and method to fully transfer power from a power source, whether that power source be a 110-volt motor, a 220-volt motor, a 12-volt, 24-volt, or 36-volt battery system or an internal combustion engine. One or more embodiments of the present invention also allow for transmission to occur in tight fitting spaces. As such, an apparatus in an embodiment of the present invention may include an extension arm that attaches to a head assembly. The drive adapter can fit onto a crank and allow fuller power transmission to crank and lower profile to clean in tight spaces. The drive adapter, the head adapter, and head sprocket of one or more embodiments of the present invention may be attached to a shaft of a motor that allows a pump to operate or attached to a crank for a cleaning device that oscillates in linear motion, or attached to a sander as such described.

In at least one embodiment of the present invention, an apparatus is provided including a head sprocket having a bore hole with a first oblong shape consisting of first, second, third, and fourth sides, the first side of the first oblong shape parallel to the second side of the first oblong shape and spaced apart from the second side of the first oblong shape, wherein the first and second sides of the first oblong shape are straight, the third and fourth sides of the first oblong shape are spaced apart from each other, substantially perpendicular to the first and second sides of the first oblong shape, wherein the third and fourth sides of the first oblong shape are curved.

The apparatus may also include a crank having a crank head having a first surface with a second oblong shape consisting of first, second, third, and fourth sides, the first side of the second oblong shape parallel to the second side of the second oblong shape and spaced apart from the second side of the second oblong shape, wherein the first and second sides of the second oblong shape are straight, the third and fourth sides of the second oblong shape are spaced apart from each other, substantially perpendicular to the first and second sides of the second oblong shape, wherein the third and fourth sides of the second oblong shape are curved.

In at least one embodiment, the crank head fits snugly into the bore hole of the head sprocket, such that the second oblong shape is substantially similar to the first oblong shape.

The apparatus may include a device including a motor, wherein the device is connected to the head sprocket so that the device causes the head sprocket to rotate which causes the crank to rotate.

The apparatus may further include a cam block comprised of first and second independent pieces which are parallel to each other, and which have a gap between them; and wherein a pin connected to the crank moves in the gap in order to move a shuttle block connected to the first and second independent pieces of the cam block. The apparatus may further include a shuttle block having at least first and second machined out pockets, wherein the shuttle block moves back and forth in response to the crank rotating. First, second, third, and fourth wear strips may be connected substantially at first, second, third, and fourth corners of the shuttle block.

The apparatus may further include a first battery; a second battery; and a battery spacer between the first battery and the second battery; wherein the first and second battery are used to power the motor; and wherein the first battery is configured to be taken out of the apparatus, then the batter spacer is configured to be taken out of the apparatus, then the second battery is configured to be taken out of the apparatus.

In at least one embodiment a method is provide including the steps of moving a shuttle block back and for in response to rotation of a crank in an apparatus, wherein the apparatus may be configured as previously described.

### BRIEF DESCRIPTION OF THE DRAWINGS

FIG. 1 shows a top view of an apparatus in accordance with an embodiment of the present invention;

FIG. 2 shows a right side partial cross sections view of the apparatus of FIG. 1;

FIG. 3 shows a top, front, and right side perspective view of the apparatus of FIG. 1, with the apparatus in a disassembled state;

FIG. 4 shows a top view of a first component of the apparatus of FIG. 1;

FIG. 5 shows a cross sectional front view of the first component of FIG. 4;

FIG. 6 shows a cross sectional closeup view of part of the first component of FIG. 4;

FIG. 7 shows a top, front, and right side view of portion of the apparatus of FIG. 1, with the portion of the apparatus 1 shown in a disassembled state;

FIG. 8A shows a front view of a drive adapter head for use in accordance with an embodiment of the present invention;

FIG. 8B shows a front, top, and right side view of the drive adapter head of FIG. 8A;

FIG. 8C shows a cross sectional view of the driver adapter head of FIG. 8A;

FIG. 8D shows a rear view of the driver adapter head of FIG. 8A;

FIG. 9A shows a front, top and right side view of a head sprocket for use with the drive adapter head of FIG. 8A;

FIG. 9B shows a rear, bottom, and left side view of the head sprocket of FIG. 9A;

FIG. 9C shows a front view of the head sprocket of FIG. 9A;

FIG. 9D shows a cross sectional view of the head sprocket of FIG. 9A, along dashed line AA shown in FIG. 9C;

FIG. 10A shows a front, top, and right side view of a modification head sprocket for use with the driver adapter head of FIG. 8A;

FIG. 10B shows a front view of the modification head sprocket of FIG. 10A; and

FIG. 10C shows a cross sections view of the modification head sprocket of FIG. 10A, along the dashed line B-B shown in FIG. 10B.

FIG. 11A shows a perspective view of a device or crank for use with the apparatus of FIG. 1;

FIG. 11B shows a side view of the device or crank of FIG. 11A;

FIG. 11C shows a top view of the device or crank of FIG. 11A;

FIG. 11D shows a cross sectional view of the device or crank of FIG. 11A;

FIG. 12A shows a top view of a nut plate for use with the apparatus of FIG. 1;

FIG. 12B shows a side view of the nut plate of FIG. 12A;

FIG. 13 shows a side view of part of chain guides, also shown in FIG. 3,

FIG. 14A shows a side view of a component shown in FIG. 2;

FIG. 14B shows a rear view of the component of FIG. 14A;

FIG. 14C shows a top view of the component of FIG. 14A;

FIG. 15A shows a rear view of a chain tensioner shown in FIG. 2;

FIG. 15B shows a side view of the chain tensioner of FIG. 15A;

FIG. 15C shows a top view of the chain tensioner of FIG. 15A;

FIG. 15D shows a perspective view of the chain tensioner of FIG. 15A;

FIG. 16A shows a side view of a battery spacer shown in what other FIG. 3 and FIG. 2;

FIG. 16B shows part of the battery spacer of FIG. 16A from the front;

FIG. 16C shows a perspective view of the battery spacer of FIG. 16A;

FIG. 17A shows a top view of a plate also shown in FIGS. 2 and 3;

FIG. 17B shows a front view of the plate of FIG. 17A; FIG. 18A shows a front, top, and left perspective view of a bearing cap

FIG. 18B shows a rear view of the bearing cap of FIG. 18A;

FIG. 18C shows a top view of the bearing cap of FIG. 18A;

FIG. 18D shows a front view of the bearing cap of FIG. 18A.

### DETAILED DESCRIPTION OF THE DRAWINGS

The present application incorporates by reference the entirety of U.S. published patent application no. U.S. published patent application no. 2004/0019989 A1 to Zahner.

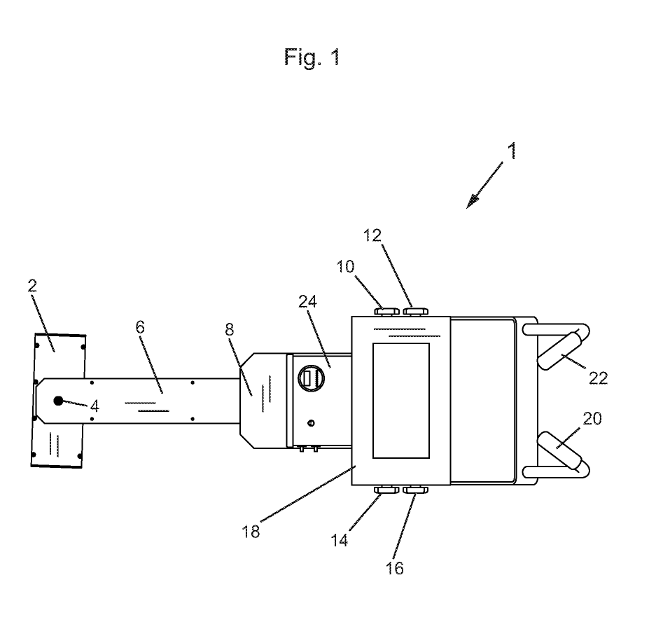

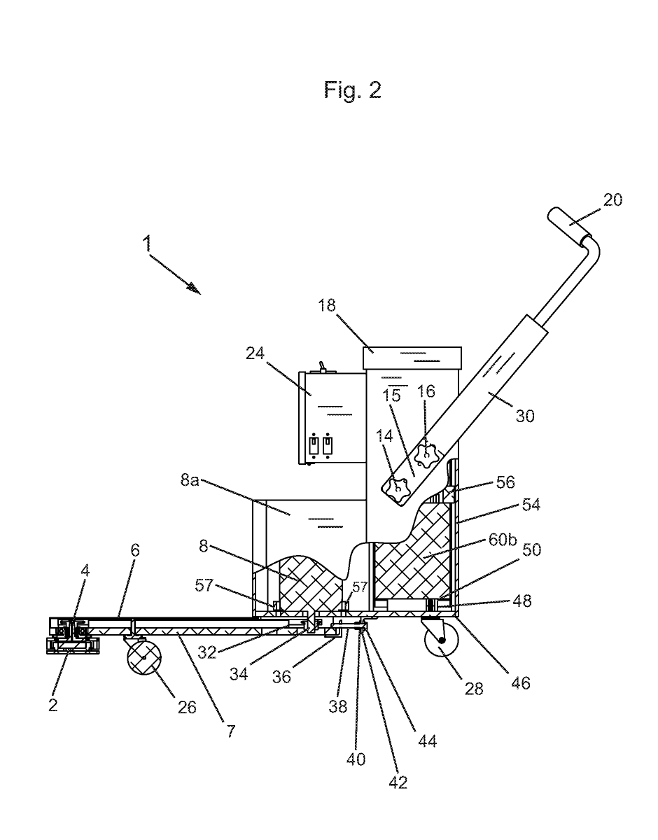

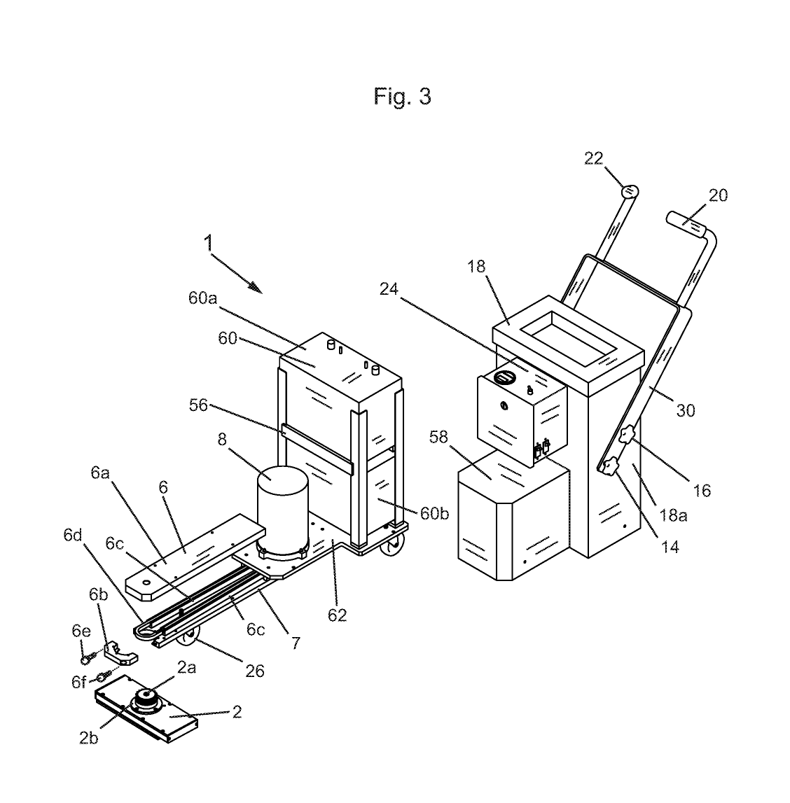

FIG. 1 shows a top view of an apparatus 1 in accordance with an embodiment of the present invention. FIG. 2 shows a right side partial cross sections view of the apparatus 1 of FIG. 1. FIG. 3 shows a top, front, and right side perspective view of the apparatus 1 of FIG. 1, with the apparatus 1 in a disassembled state;

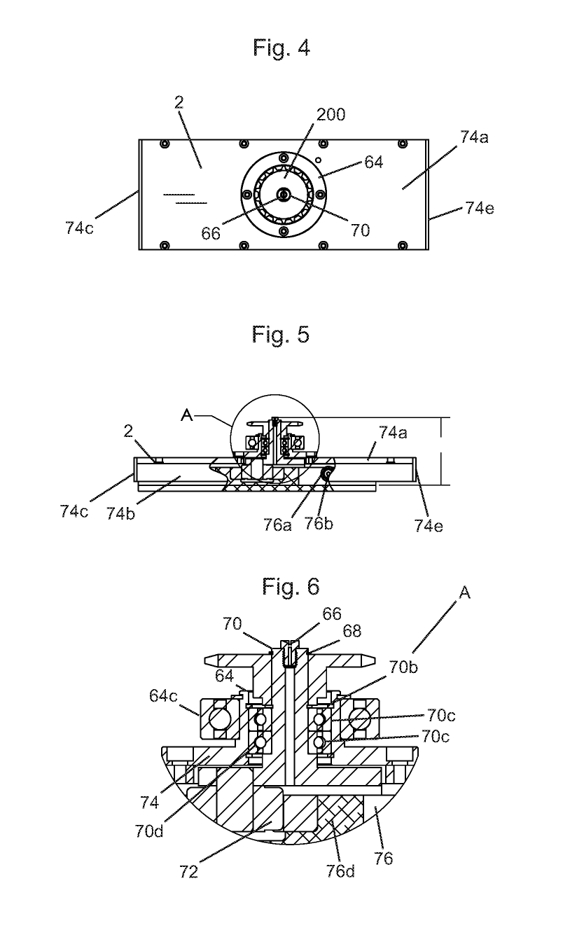

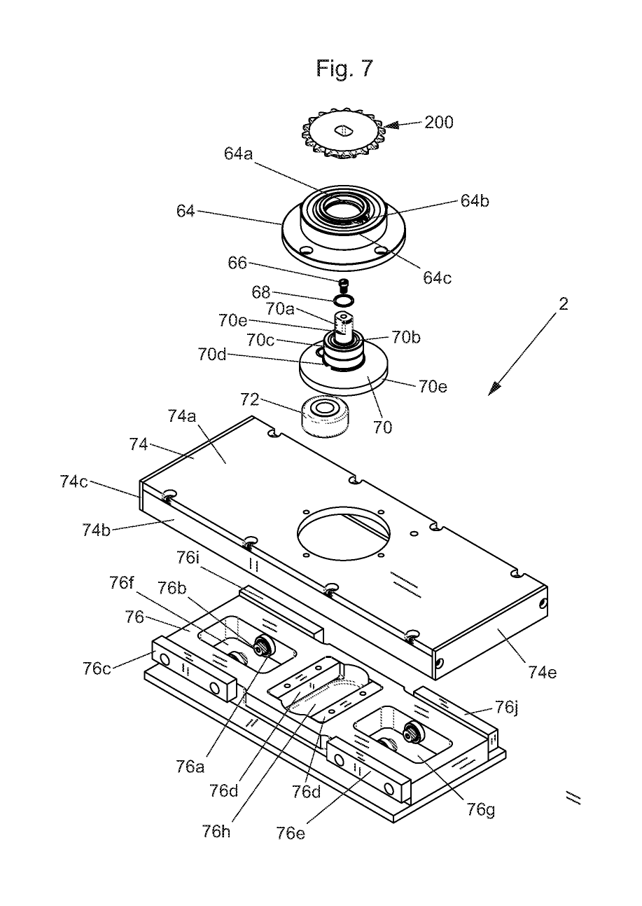

FIG. 4 shows a top view of a first component of the apparatus 1 of FIG. 1. FIG. 5 shows a cross sectional front view of the first component of FIG. 4. FIG. 6 shows a cross sectional closeup view of part of the first component of FIG. 4. FIG. 7 shows a top, front, and right side view of portion of the apparatus 1 of FIG. 1, with the portion of the apparatus 1 shown in a disassembled state.

Referring to FIGS. 1-3, the apparatus 1 includes an assembly head 2, a pivot pin 4, an extension arm 6, a motor 8, knobs 10, 12, 14, and 16, a cover and pad holder 18, handles 20 and 22, assembly electrical box 24, wheel or rollers 26 and 28, handle bar 30, spacer block 32, sprocket 34, bracket tensioner (threaded) 36, hex bolt 38, lock nut 40, bracket chain tensioner 42, washer (typically oversized) 44, main chassis plate 46, bracket for battery 48, mounting block cover 50, battery (typically twelve volts deep cycle) 52, main cover 54, spacer (for battery) 56, motor housing 58, a plurality of batteries 60, including top battery 60a and bottom battery 60b, and plate 62.

Referring to FIG. 7, a perspective view of a head sprocket 200 is shown, along with bearing housing head pivot 64, grease fitting 66, spiral retaining ring 68, a device 70, cam follower 72, a device 74, and a device 76.

The bearing housing head pivot 64 includes retaining ring 64a, retaining ring 64b, ball bearing 64c.

The device 70 includes crank head 70a, retaining ring 70b, ball bearing 70c, and retaining ring 70d.

The device 74 includes a top plate head 74a, a shuttle rail head 74b, and an end plate 74c.

The device 76 includes a ball bearing 76a, a shoulder screw 76b, a wear strip head 76c, a cam block 76d, and a wear strip head 76e.

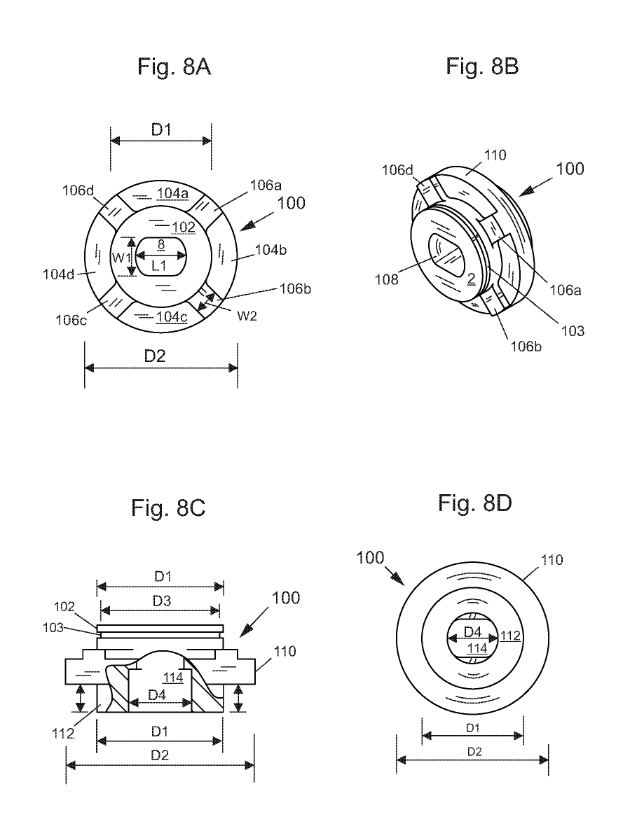

FIG. 8A shows a front view of a drive adapter head 100 for use in accordance with an embodiment of the present invention. FIG. 8B shows a front, top, and right side view of the drive adapter head 100 of FIG. 8A. FIG. 8C shows a cross sectional view of the driver adapter head 1 of FIG. 8A. FIG. 8D shows a rear view of the driver adapter head 100 of FIG. 8A.

The driver adapter head 100 includes a front surface 102, and indentation or circular groove 103, surfaces 104a, 104b, 104c, and 104d, and projections, protrusions, or ribs 106a, 106b, 106c, and 106d. The driver adapter head 100 has an opening and/or bore 108, which may have a length, L1 which may be about 0.5 inches and a width W1 which may be about 0.375 inches. Each projection of projections 106a, 106b, 106c, and 106d, may have a width W2 which may be about 0.25 inches.

The front surface or section 102 may have a diameter D1 shown in FIG. 8C, which may be about 0.999 inches; the groove 103 may have a diameter D3 shown in FIG. 8C, which may be about 0.940 inches; the opening or bore 108 leads to an opening or bore 114 which may have a diameter D4 of about 0.5 inches. The overall drive adapter head 100 may have a diameter D2, which may be about 1.5 inches.

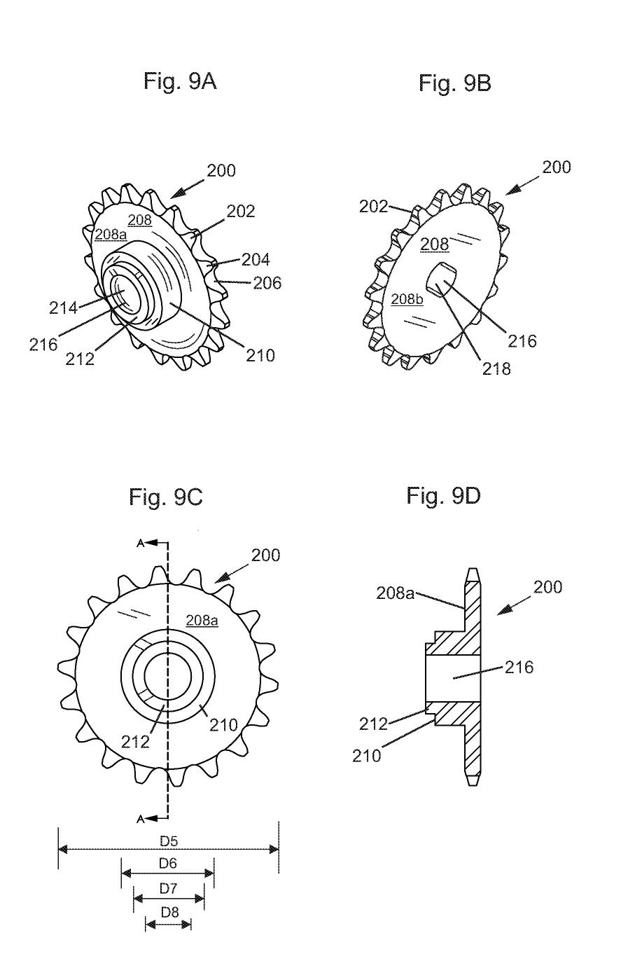

FIG. 9A shows a front, top and right side view of a head sprocket 200 for use with the drive adapter head 100 of FIG. 8A. FIG. 9B shows a rear, bottom, and left side view of the head sprocket 200. FIG. 9C shows a front view of the head sprocket 200. FIG. 9D shows a cross sectional view of the head sprocket 200 along dashed line AA shown in FIG. 9C.

The head sprocket drive adapter combo 200 includes gear teeth 202 including protrusions 204, and troughs or indentations 206. The head sprocket 200 includes flat section 208 having front surface 208a and rear surface 208b. The head sprocket 200 includes a cylinder section 210, and a cylinder sections 212. There is an opening 214 in cylinder 212 leading to an inner chamber or bore 216, which leads to an opening 218 in flat section 208. The head sprocket 200 may be made completely of a hard metal, and may be an integrated piece. The head sprocket 200 may have an overall diameter D5, which may be 2.35 inches. The cylinder 210 may have an outer diameter D6 which may be one inch. The cylinder 212 may have an outer diameter D7 which may be 0.750 inches and an inner diameter D8 which may be 0.4996 inches.

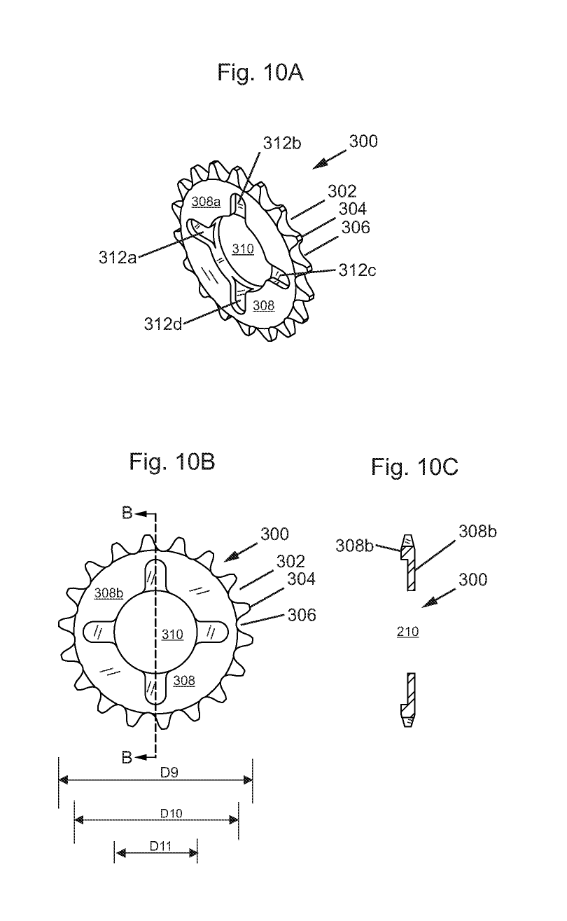

FIG. 10A shows a front, top, and right side view of a modification head sprocket 300 for use with the driver adapter head 100 of FIG. 8A. FIG. 10B shows a front view of the modification head sprocket 300. FIG. 10C shows a cross sections view of the modification head sprocket 300 of FIG. 10A, along the dashed line B-B shown in FIG. 10B.

The modification head sprocket 300 includes gear teeth 302 including peaks or protrusions 304, and troughs or indentations 306. The medication head sprocket 300 has a flat section 308 having a front surface 308a and a rear surface 308b. The modification head sprocket 300 has a central opening or bore 310, and indentations 312a, 312b, 312c, and 312d. The modification head sprocket 300 may be made of entirely of a hard metal. The modification head sprocket 300 has an overall diameter D9 which may 0.2.3340 inches. The section 308 has a diameter D10 which may be 1.985 inches. The opening or bore 310 has a diameter of D11 which may be 0.991 inches.

The bore 108 of the driver adapter head 100, shown in FIG. 8B, is uniquely shaped to allow a similar uniquely shaped crank head or shaft 70a of FIG. 7 to be inserted into the bore 108 thereby allowing for less slippage on a crank head or shaft 70a of FIG. 7 allowing for better power transfer and distribution. In this case, a chain ANSI (American National Standards Institute) thirty-five is run from the motor 8 FIG. 3 to such modification head sprocket 300, crank head or shaft 70a of FIG. 7 to assist in the power transfer. The detent 312a number if FIG. 10a shown in FIGS. 10A and 10B correspond to knobs 106d number of FIGS. 8a and 8b. The modification head sprocket 300 fits into these detents 106d numbers FIGS. 8a, 8b and is held in place by a spiral ring 68 number FIG. 7. FIGS. 9a to 9d are a one piece embodiment of the above two parts and is a similar method for power transmission.

The head sprocket 200 shown in FIG. 7 and in FIGS. 9A-9D as used, at least in combination with other components shown in FIG. 7, provides an improvement over known devices. The head sprocket 200, in at least one embodiment, is a custom made sprocket that had an oblong type bore hole 216 to receive crank head 70a of the crank or device 70 showing the ears 70a to fit in the opening or bore 216 of the head sprocket 200. This configuration allows for far less slippage (as was the case in a prior known configuration of a pulley) and better transfer of power to the crank or device 70 and subsequently the shuttle block 76 shown in FIG. 7. It is also an improvement in that one or more embodiments of the present invention allow for a much longer life cycle of the head sprocket 200 and the crank head 70a and crank or device 70, than prior known parts and also is an improvement in that one or more embodiments of the present invention provide much longer time to elapse between service intervals.

Additionally, device or crank 70 is improved over the prior known devices, such as crank 108 shown in FIG. 4, of prior U.S. published patent application no. 2004/0019989 A1 to Zahner, in that crank or device 70 of one or more embodiments of the present application, has a machined oblong section or crank head 70a at the top of the crank or device 70 to allow the bore 216 of the head sprocket 200 to fit snug and reduces slippage as well as power transfer. Additionally the configuration shown in FIG. 7 of the present application, differs from the configuration shown in FIG. 4 of prior U.S. published patent application no. 2004/0019989 A1 to Zahner, in that one or more embodiments of the present invention, has a step 70e at the bottom of the ear or crank head 70a which stops the sprocket 200 from ‘torqueing’ down the crank or device 70 and rubbing on the bearing housing or ball bearing 70c.

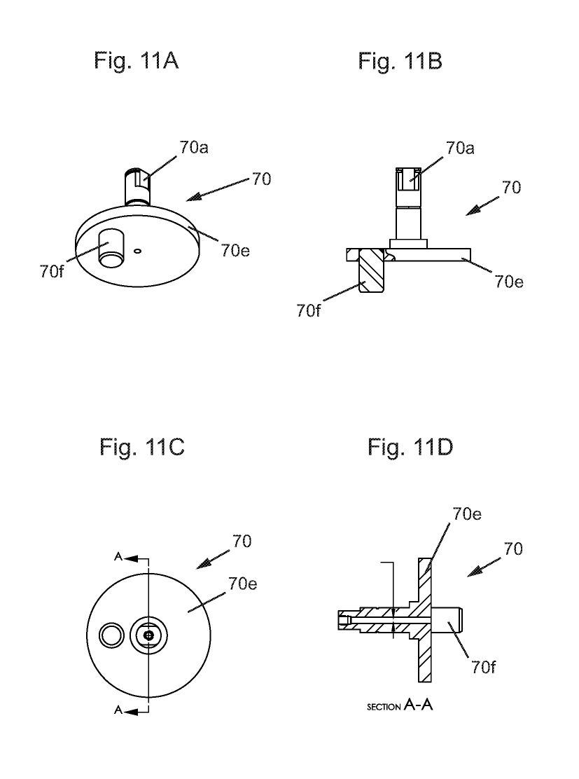

In addition, in the prior U.S. published patent application no. 2004/0019989 A1 to Zahner, a crank pin 108c in FIG. 4 of U.S. published patent application no. 2004/0019989 A1 is close to the edge, while in one or more embodiments of the present invention, the crank or device 70 shown in FIG. 7 has a larger crank pin 70f shown in FIG. 11A. which may protrude out ⅝ of an inch instead of three eighths of an inch and is moved closer into the center giving more strength to the crank pin 70f increasing reliability and far less breakdown from a blowout of the crank edge.

In addition, in one or more embodiments of the present invention the grease fitting 66 is provided, and this was not provided in the prior device shown in FIG. 4 of U.S. published patent application no. 2004/0019989 A1.

The grease fitting 66, in one or more embodiments of the present application is attached to the top of crank 70 66 in FIG. 7 and this allows the bearing 72 to be greased. The crank 70 has a small hole bored thru the entire crank from fitting 66 to the crank bottom that allows the grease to flow thru to the bearing pocket where bearing 72 is located and needs greased. The prior configuration of FIG. 4 of U.S. published patent application no. 2004/0019989 A1 had no way to grease the bearings 128a-b causing early freeze up of the bearings 128a-b, i.e. one would need to take apart the bearing housing 107 of U.S. published patent application no. 2004/0019989 A1, a long process to grease the bearings 128a-b. In the prior known apparatus in some cases a fitting would be attached to the shuttle block 102 thru a hole in pad plate 101 shown in FIG. 4 of U.S. published patent application no. 2004/0019989 A1 and the machine would have to be tilted back to grease. The position of that fitting, in a prior known apparatus was not practical because the machine would fall backward injuring an operator to just grease the bearing in the head.

In contrast, in one or more embodiments of the present application, the bearing 72 can be easily be greased from the top at location 66 identify by number in FIG. 7, while the overall apparatus 1 of FIGS. 1-2 is just sitting there, and literally only takes a couple of seconds to do as shown in FIG. 1. The prior known apparatus of FIG. 4 of U.S. published patent application no. 2004/0019989 A1 requires fifteen minutes to take apart and reassemble or have an injury.

The bearing housing head pivot 64 of the present application is an improvement over the prior bearing housing 107 of FIG. 4 of U.S. published patent application no. 2004/0019989. The prior bearing housing 107 had a step machined in it which weakened that prior bearing housing 107 and required two shims to make up the difference. The bearing housing head pivot 64, of one or more embodiments of the present application, eliminated this design flaw and strengthens the bearing housing head pivot 64 thereby removing the ‘fracture’ of the metal which could occur in the prior bearing housing 107.

The device 74 includes a top plate head 74a, a shuttle rail head 74b, and an end plate 74c. The device 74, shown in FIG. 7 of the present application, includes end plate 74c. In contrast, the prior apparatus of FIG. 4 of U.S. published patent application no. 2004/0019989 A1 had a plate 105 which did not include an end plate. The end plate 74c of FIG. 7 of the present application helps to prevent undesirable splashing of cleaning solution on other parts of apparatus 1. In the prior apparatus of FIG. 4 of U.S. published patent application no. 2004/0019989 A1, cleaning solution undesirably splashed on merchandise, end users, other equipment, etc. With the introduction of the end plates 74c and 74e shown in FIG. 7 of the present application, the likelihood of undesirable splashing of cleaning solution occurring is now eliminated as the end plates 74c and 74e contain the splashing liquid.

Cam block 76d of FIG. 7 of the present application is an improvement over the known cam block 103 of FIG. 4 of U.S. published patent application no. 2004/0019989 A1. In at least one embodiment, cam block 76d of FIG. 7 of the present application is actually two pieces whereas known cam block 103 of FIG. 4 of U.S. published patent application no. 2004/0019989 A1 is one piece. The advantage is this allows better absorption of the forces of the crank bearing 70c of FIG. 7 in at least one embodiment of the present application. With the one piece design, the known crank 108 of Zahner '989 would pull on the opposite end of the cam block 103 as the bearing 129 would be rotated. As the bearing 129 rotated, the bearing 129 would always be pulling on the opposite side of known cam block 103. Eventually this loosens and elongate the fasteners and fasteners holes in the prior known shuttle block 102. By using two substantially parallel pieces for cam block 76d in the present application, machined bigger and now separated, the force absorption is better and the elongated holes and fasteners becoming loose are eliminated, in the current shuttle block 76 of FIG. 7 of the present application.

Also the shuttle block 76 of FIG. 7 of the present application is an improvement from the prior shuttle block 102 of FIG. 4 of U.S. published patent application no. 2004/0019989 A1, in that the front and back end of shuttle block 76 are machined out revealing two pockets or inner chambers 76f and 76g shown in FIG. 7 of the present application. These pockets 76f and 76g, and pockets on the back end of shuttle block 76 not shown, allow the shuttle block 76 to be lighter than the prior known shuttle block 102 of FIG. 4 of U.S. published patent application no. 2004/0019989 A1. This also allows for less wear and tear on the apparatus 1 of FIGS. 1 and 2, as a whole as the shuttle block 76 is the part that is moving back and forth several thousand times a minute. The reduction in weight of shuttle block 76 allows longer run time on a DC (direct current) or gas operated power source.

Also there is a third pocket or central pocket 76h shown in FIG. 7 of the present application, where the cam block 76d is located. The third pocket 76h is thicker on the edge as opposed to the prior configuration of a straight machined edge for the central region of prior known shuttle block 102 shown in FIG. 4 of U.S. published patent application no. 2004/0019989 A1. The benefit and improvement of the configuration of central pocket 76h shown in FIG. 7 of the present application is that in the prior known crank bearings 129 of Zahner '989 would ‘blow out’ the edges of the known shuttle block 102 and cause cracking that would weaken the shuttle block 102 and pose a high risk of failure and damage. The improved configuration of shuttle block 76 in this area of central pocket 76h shown in FIG. 7 of the present application, eliminates or greatly reduces this flaw and increases safety and reliability.

In the prior known configuration of FIG. 4 of U.S. published patent application no. 2004/0019989 A1, wear strips 106a and 106b were located along a center line of shuttle block 102. This configuration as the prior device was used, would cause wear strips 106a and 106b to wear prematurely and allow the prior shuttle block 102 to wobble side to side causing a very loud noise that required ear protection for the end user.

In contrast, in the shuttle block 76 of FIG. 7 of the present application 106, wear strip heads or parts 76c, 76e, 76i, and 76j, are moved to the four corners or ends of shuttle block 76. This is an improvement in that it eliminates or greatly reduces premature wear of the wear strips 76c, 76e, 76i, and 76j in FIG. 7 of present application, and improves the performance in that the shuttle block 76 no longer wobbles side to side and does not damage the end users hearing or require hearing protection.

In at least one embodiment of the present application, component 300 shown in FIGS. 10A-10C and component 100 shown in FIGS. 8A-8D may be combined together to form head sprocket 200 shown in FIGS. 9A-9D, or an identical or similar head sprocket. For example, component 300 may be rested on top of component 100 with the opening 310 of component 300 aligned with surface 102, such that the diameter D1 of component 100 is about the same as the diameter of the opening 310. Components 100 and 300 may be tac welded together after surface 102 and opening 310 are aligned, to form the one piece head sprocket 200.

Alternatively, the head sprocket 200 may be a one piece component as shown in FIGS. 9A-9D. Subsequently FIGS. 9A-D is another way of doing what is described in the preceding paragraph regarding welding components 100 and 300 together.

So in FIG. 7, head sprocket 200 is the one piece component just mentioned, or in its place could be components 100 and 300 tac welded together to accomplish the same thing. The head sprocket 200 of FIGS. 9A-9D is the better way to do this; and the tooling is typically completely custom tooling to accomplish this.

Also operationally to the changes already mentioned, one or more embodiments of the present invention provide a more reliable and robust configuration and improvement shown in the FIGS. 1-10C which allows the apparatus 1 to operate at a 48% increased speed of the shuttle block 76 compared to the speed of the shuttle block 102 of prior U.S. published patent application no. 2004/0019989 A1 to Zahner, making the apparatus 1 far more productive, than the device provided in the prior published patent application to Zahner, as well.

As shown in FIG. 2 of the present application, components 36, 38, 40, 42, and 44, together may be called a chain tensioner system. In the prior device of U.S. published patent application no. 2004/0019989 to Zahner (hereinafter Zahner '989 reference) there was no tensioner at all, rather there were slots made in prior known component or arm 36 where four holes are that bolts 36a went through. Therefore in the prior known device of Zahner '989, when one had to adjust the belt 64 one had to loosen four bolts 36a and had to hit the arm 36 with a hammer to adjust the arm 36 or use a pry bar to pry the arm 36 forward along those slots to adjust.

In contrast, in one or more embodiments of the present application, the four bolts shown and identify by number in FIG. 2 of present application, devices 57 are loosened and a bolt 44 in FIG. 2 in the tensioner or system comprised of components 36, 38, 40, 42, and 44 is simply turned in a clockwise or counter clockwise direction to move the arm 6 in or out depending on the need of the chain 6d. This is a far better way of adjusting the tension of the chain 6d shown in FIG. 3. In FIG. 3, component 6c is the guide and in it is chain 6d. Also it is more precise to allow the proper tension on the chain 6d to prevent premature wear or breakage due to over tightening. Also there is no damage to the machine or apparatus 1 or the arm 6 from using a pry bar or hitting it with a hammer.

Also in the current application in FIG. 3 component 6b is known as a bearing cap. In the prior application of Zahner '989 there was no bearing cap. Component 42 shown in FIG. 1 of Zahner '989 was pressed into component 37c of FIG. 3 in Zahner '989. When component or head assembly 42 of Zahner '989 needed to be serviced or repaired it needed to be pressed out with a bearing press or hammered out with a heavy hammer, possibly causing damage to the crank 108b in FIG. 4 of Zahner '989. If a bearing press was needed the entire arm 36 in FIG. 3 of Zahner '989, it had to be removed from the machine often taking an hour to just get the head assembly 42 of Zahner '989 off just to service it.

In one or more embodiments of the present invention, by simply removing the two retaining bolts 6e and 6f holding component 6b onto the extension arm 6, wherein component 6a is the chain cover. The head assembly 2 can simply be lifted away with ease. The time to do this is literally just a minute or two.

Also FIG. 3 of the present application shows the addition of wheel 26. This is known as the transport wheel 26. In the prior application of Zahner '989 there was no analogous wheel, i.e. only wheels 32 located in the back shown in FIG. 2 of Zahner '989 were used to transport the machine. Due to that location the machine could not be pushed forward to transport but always had to be pulled backwards, causing the machine to be behind the person moving the machine and being awkwardly in a user's hand sometimes causing a loss of grip and dropping the machine backwards on the floor as it had to be tilted up a steep angle to transport, possibly causing harm to the machine or user, also leading to battery acid leakage.

In one or more embodiments of the present application component or transport wheel 26 shown in FIG. 3 allows the apparatus 1 to be transported in it's natural position and the apparatus 1 can be moved forward or backward with ease eliminating all or most of the concerns noted above with the prior device of Zahner '989.

Also FIG. 3 of the present application shows chain guides 6c which were not present in the prior application of Zahner '989. In the present application, due to the length from the motor 60 to the sprocket 200 (shown in FIG. 7) or a sprocket including devices 100 (of FIGS. 8A-8D) and 300 (of FIGS. 10A-C) combined (prior was pulley for belt) there would be excessive wobble of the chain 6d due to the traveled distance, and the wobble would cause premature chain 6d failure and wear, but that is reduced or eliminated by chain guides 6c. Without chain guides 6c, the chain 6d may only last ten hours. To put on a new chain 6d required a lot of disassembly and time. The guides 6c prevent or substantially reduce wobble of the chain 6d. Because of chain guides 6c, the chain 6d has no excessive wear and this prevents premature wear and reduces wear on the sprocket 200 (or combination of 100 and 300). Also the apparatus 1 runs in a much smoother way with less vibration as the chain guides 6c inhibit the wobble. In the prior device of Zahner '989, a belt was used instead of a chain, however, there were no guides analogous to the guides 6c.

Also in one or more embodiments of the present application, FIG. 2, shows a battery spacer 56. In the prior application of Zahner '989, battery brackets did not have battery spacer analogous to battery spacer 56, so three battery brackets had to be installed, then a bottom battery in Zahner '989, analogous to bottom battery 60b in FIG. 3, needed to be wedged in to position it, then a last battery bracket installed. In the prior device of Zahner '989 there were pieces welded to the battery brackets that a top battery, analogous to battery 60a would sit on. However when the bottom battery of the prior device of Zahner '989, analagous to battery 60b, would need to be replaced, the carcass or housing of the motor of Zahner '989, analagous to 8a shown in FIG. 2 would need to be removed, a wiring harness, such as including analogous to component 24 shown in FIG. 3, nearly completely removed, and a fourth battery bracket removed just to gain access to a bottom battery (analogous to battery 60b in FIG. 2). This process for Zahner '989 was an intensive operation just to get to a battery.

In one or more embodiments of the present invention, the top battery 60a shown in FIG. 3 is simply lifted out of place and the battery spacers 56 shown in FIG. 3 are simply lifted out and the bottom battery 60a shown in Fig. number FIG. 2 can also simply be lifted out. This is an easy and quick way to access the lower or bottom battery 60b and is a major improvement in design, serviceability, and ease of maintenance, compared to the apparatus of the prior device of Zahner '989.

In addition, in the prior application of Zahner '989, FIG. 2 shows a nut plate 52 that was held in place by the knobs 21-24. If two knobs of 21-24 were removed on any side for any reason, the nut plate 52 would fall to the chassis plate 62 and get trapped between the battery 218 shown in FIG. 2 and the carcass or housing 25 of Zahner '989. The prior known nut plate 52 of Zahner '989 would then be impossible to get to without removing the two batteries, and this would be a very intensive operation as described above.

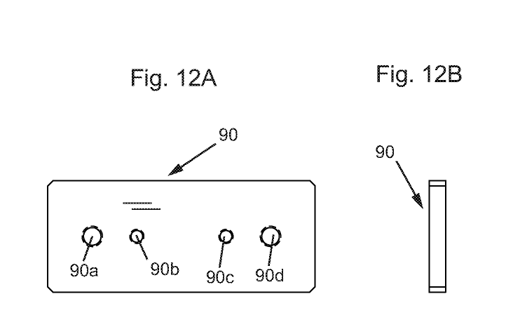

A new nut plate, nut plate 90, is shown in FIGS. 12a-12b. The nut plate 90 has holes 90a, 90b, 90c, and 90d. The prior known nut plate 52 of Zahner '989 did not have holes analogous to inner holes 90b and 90c. The inner holes 90b and 90c correspond to two holes in the carcass or housing 8a for the motor, batteries and wiring harness 8 and with corresponding bolts the inner holes 90b and 90c help to hold the nut plate 90 shown in FIGS. 12a-12b to the carcass or housing 8a instead of simply being held in place by adjustment knobs 10, 12, 14, and 16. In the prior application of Zahner '989 of FIG. 2, adjustment knobs 21-24, which are analogous to adjustment knobs 10, 12, 14, and 16 of the present application, solely held the nut plate in Zahner '989, in place.

The inner holes 90b and 90c of the present application, and corresponding bolts, prevent the nut plate 90, from falling and getting ‘lost’ between the bottom battery 60band the carcass or housing 8a. With the prior known patent application of Zahner '989, if an end user were to lose the nut plate 52 of Zahner '989 by removing two knobs on one side of knobs 21-24, to adjust the function, the entire machine was rendered inoperable as there was no secure handle to maneuver the machine. A disassembly of the prior known device of Zahner '989, including disassembly of a carcass or motor housing analogous to 8a of the present application, a wiring harness analogous to 24 of the present application, a battery bracket, and batteries were all needed just to get the nut plate back and reattach. One or more embodiments of the present application completely eliminates this concern and problem.

FIG. 11A shows a perspective view of a device or crank 70 for use with the apparatus 1 of FIG. 1. FIG. 11B shows a side view of the device or crank 70 of FIG. 11A. FIG. 11C shows a top view of the device or crank 70 of FIG. 11A. FIG. 11D shows a cross sectional view of the device or crank 70 of FIG. 11A.

FIG. 12A shows a top view of a nut plate 90 for use with the apparatus 1 of FIG. 1. FIG. 12B shows a side view of the nut plate 90 of FIG. 12A. The location of the nut plate 90 is shown at 15 in FIG. 2, and the nut plate 90 would be inside of housing 18a shown in FIG. 3, and aligned with a portion of the arm 30 so that nuts of knobs 14 and 16 can pass through holes in the nut plate 90, to hold arm 30 to the housing 18a or overall housing or carcass.

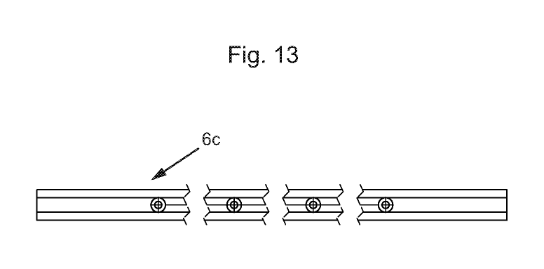

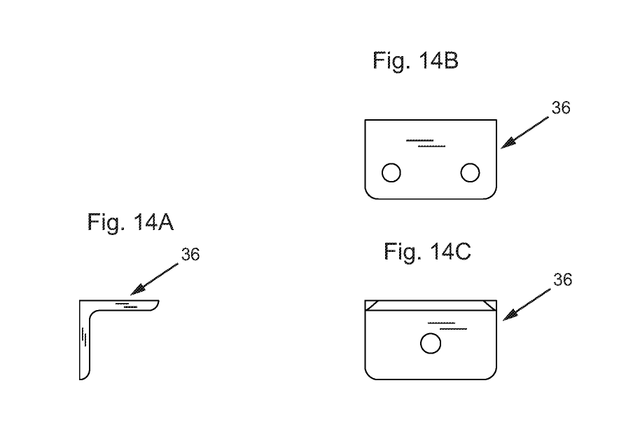

FIG. 13 shows a top view of part of chain guides 6c, also shown in FIG. 3. FIG. 14A shows a side view of a component 36 shown in FIG. 2. FIG. 14B shows a rear view of the component 36 of FIG. 14A. FIG. 14C shows a top view of the component 36 of FIG. 14A.

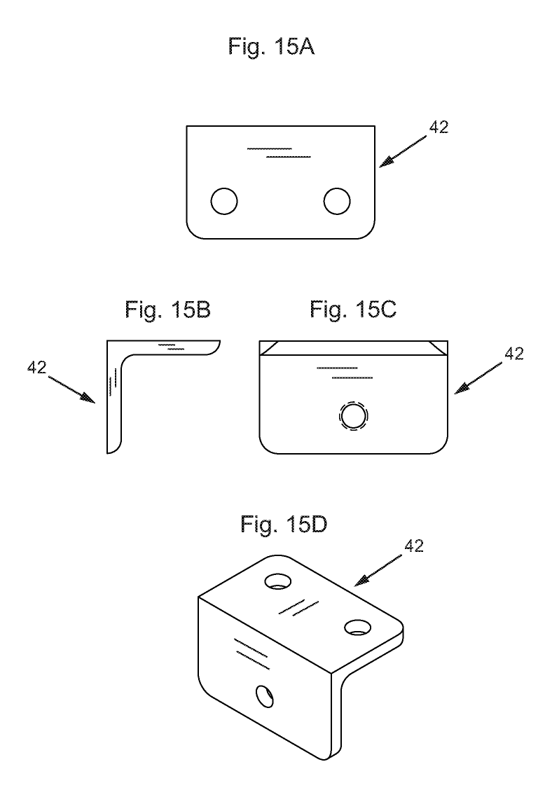

FIG. 15A shows a rear view of a chain tensioner 42 shown in Fig.2. FIG. 15B shows a side view of the chain tensioner 42 of FIG. 15A. FIG. 15C shows a top view of the chain tensioner 42 of FIG. 15A. FIG. 15D shows a perspective view of the chain tensioner 42 of FIG. 15A.

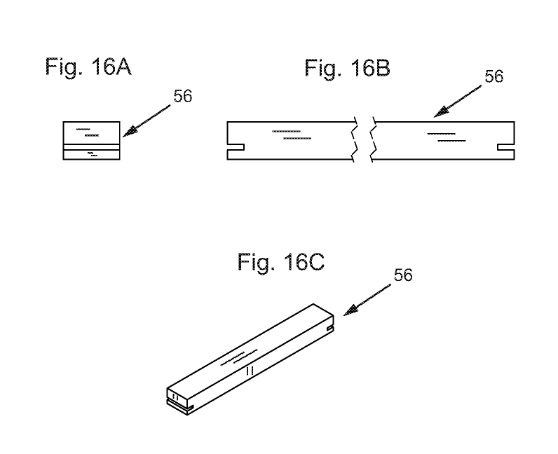

FIG. 16A shows a side view of the battery spacer 56 shown in FIG. 3 and FIG. 2. FIG. 16B shows part of the battery spacer 56 from the front. FIG. 16C shows a perspective view of the battery spacer 56.

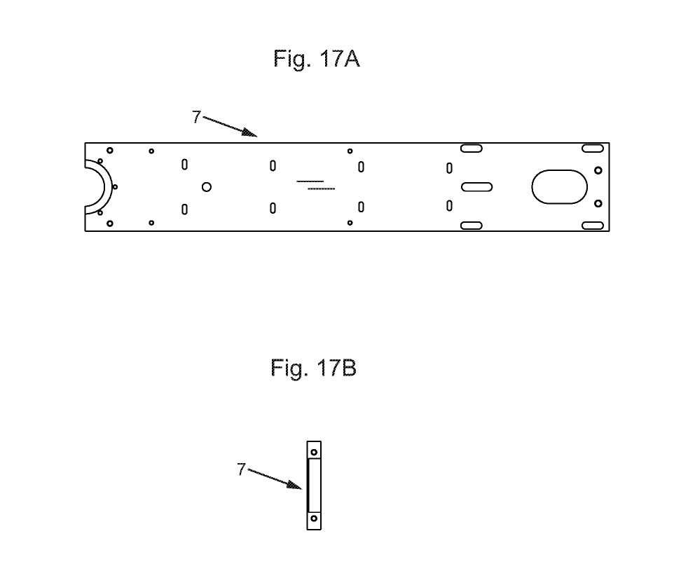

FIG. 17A shows a top view of a plate or extension arm 7 also shown in FIGS. 2 and 3. FIG. 17B shows a front view of the plate 7 of FIG. 17A;

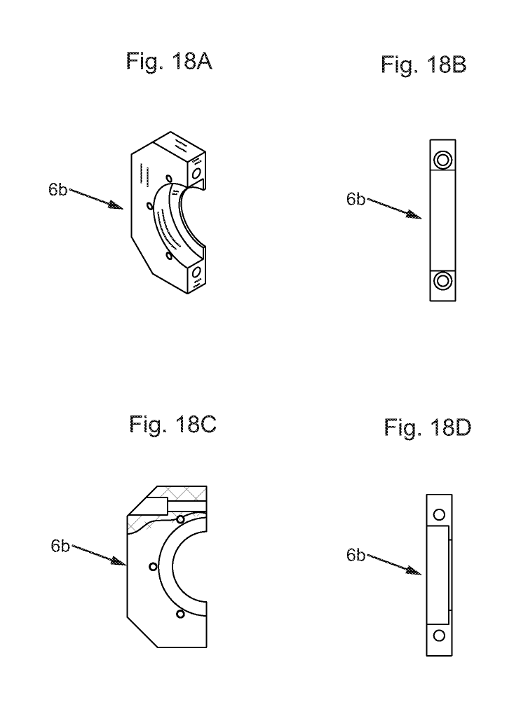

FIG. 18A shows a front, top, and left perspective view of the bearing cap 6b. FIG. 18B shows a rear view of the bearing cap 6b of FIG. 18A. FIG. 18C shows a left view of the bearing cap 6b of FIG. 18A. FIG. 18D shows a front view of the bearing cap 6b of FIG. 18A.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a head sprocket having a bore hole with a first oblong shape consisting of first, second, third, and fourth sides, the first side of the first oblong shape parallel to the second side of the first oblong shape and spaced apart from the second side of the first oblong shape, wherein the first and second sides of the first oblong shape are straight, the third and fourth sides of the first oblong shape are spaced apart from each other, substantially perpendicular to the first and second sides of the first oblong shape, wherein the third and fourth sides of the first oblong shape are curved;
a crank having a crank head having a first surface with a second oblong shape consisting of first, second, third, and fourth sides, the first side of the second oblong shape parallel to the second side of the second oblong shape and spaced apart from the second side of the second oblong shape, wherein the first and second sides of the second oblong shape are straight, the third and fourth sides of the second oblong shape are spaced apart from each other, substantially perpendicular to the first and second sides of the second oblong shape, wherein the third and fourth sides of the second oblong shape are curved; and
wherein the crank head fits snugly into the bore hole of the head sprocket, such that the second oblong shape is substantially similar to the first oblong shape.

2. The apparatus of claim 1 further comprising
a device including a motor; and
wherein the device is connected to the head sprocket so that the device causes the head sprocket to rotate which causes the crank to rotate.

3. The apparatus of claim 1 further comprising
a cam block comprised of first and second independent pieces which are parallel to each other, and which have a gap between them; and
wherein a pin connected to the crank moves in the gap in order to move a shuttle block connected to the first and second independent pieces of the cam block.

4. The apparatus of claim 2 further comprising
a shuttle block having at least first and second machined out pockets; and
wherein the shuttle block moves back and forth in response to the crank rotating.

5. The apparatus of claim 2 further comprising
a shuttle block;
first, second, third, and fourth wear strips connected substantially at first, second, third, and fourth corners of the shuttle block; and
wherein the shuttle block moves back and forth in response to the crank rotating.

6. The apparatus of claim 2 further comprising
a first battery;
a second battery;
a battery spacer between the first battery and the second battery;
wherein the first and second battery are used to power the motor; and
wherein the first battery is configured to be taken out of the apparatus, then the batter spacer is configured to be taken out of the apparatus, then the second battery is configured to be taken out of the apparatus.

7. A method comprising the steps of :
moving a shuttle block back and for in response to rotation of a crank in an apparatus;
wherein the apparatus includes a head sprocket having a bore hole with a first oblong shape consisting of first, second, third, and fourth sides, the first side of the first oblong shape parallel to the second side of the first oblong shape and spaced apart from the second side of the first oblong shape, wherein the first and second sides of the first oblong shape are straight, the third and fourth sides of the first oblong shape are spaced apart from each other, substantially perpendicular to the first and second sides of the first oblong shape, wherein the third and fourth sides of the first oblong shape are curved;
wherein the apparatus include the crank having a crank head having a first surface with a second oblong shape consisting of first, second, third, and fourth sides, the first side of the second oblong shape parallel to the second side of the second oblong shape and spaced apart from the second side of the second oblong shape, wherein the first and second sides of the second oblong shape are straight, the third and fourth sides of the second oblong shape are spaced apart from each other, substantially perpendicular to the first and second sides of the second oblong shape, wherein the third and fourth sides of the second oblong shape are curved;
wherein the crank head fits snugly into the bore hole of the head sprocket, such that the second oblong shape is substantially similar to the first oblong shape;
and wherein the apparatus includes a device including a motor; and
wherein the device is connected to the head sprocket so that the device causes the head sprocket to rotate which causes the crank to rotate.

8. The method of claim 7 wherein
the apparatus includes a cam block comprised of first and second independent pieces which are parallel to each other, and which have a gap between them; and
wherein a pin connected to the crank moves in the gap in order to move a shuttle block connected to the first and second independent pieces of the cam block.

9. The method of claim 7 wherein
the apparatus includes a shuttle block having at least first and second machined out pockets; and wherein the shuttle block moves back and forth in response to the crank rotating.

10. The method of claim 7 wherein
the apparatus includes a shuttle block, and first, second, third, and fourth wear strips connected substantially at first, second, third, and fourth corners of the shuttle block; and
wherein the shuttle block moves back and forth in response to the crank rotating.

11. The method of claim 7 wherein
the apparatus includes a first battery; a second battery; and a battery spacer between the first battery and the second battery;
wherein the first and second battery are used to power the motor; and
wherein the first battery is configured to be taken out of the apparatus, then the batter spacer is configured to be taken out of the apparatus, then the second battery is configured to be taken out of the apparatus.
